(19) United States
(12) Patent Application Publication
(10) Pub. No.: US 2026/0320628 A1
(43) Pub. Date: Oct. 15, 2026

(54) METHODS AND SYSTEMS FOR AUTOMATIC PROJECT SITE SAFETY ASSESSMENT

(71) Applicant: DroneDeploy, Inc., San Francisco, CA (US)

(72) Inventors: Philip LORENZO, Davis, CA (US); Nicholas PILKINGTON, Seattle, WA (US); Benjamin GALLISHAW, Skaneateles, NY (US)

(21) Appl. No.: 19/179,887

(22) Filed: Apr. 15, 2025

(51) Int. Cl. G06Q 30/018

(52) U.S. Cl. CPC G06Q 30/018

(57) ABSTRACT

A computer-implemented method for monitoring project site safety includes receiving, via processors coupled to an imaging system, unprocessed imaging data of a region of interest, including multiple captured images. The method processes the data using an image processing model to deduplicate images and generate a processed image set. A vision large language model analyzes the processed images to identify a safety condition related to a physical structure or site state. The analysis includes feature extraction to produce structured data representations, identifying safety conditions based on relationships or labels in the data, determining a semantic category using a transformer-based neural network, and generating a textual description of the safety condition based on the semantic category.

### TECHNICAL FIELD

The present disclosure relates to methods and systems for automatically processing, analyzing, and describing source files of imaging data for construction safety assessment applications. More specifically, the present disclosure relates to methods and systems for automatically generating descriptions of safety anomalies on a project site based on imaging data.

### BACKGROUND

Ensuring the safety of personnel on project sites in the construction and industrial sectors is of paramount importance. Conventional methods for safety oversight involve manual site visits, reliance on human observation, and application of a patchwork of in-house rules and externally mandated regulations.

Traditional technological approaches to detection of safety anomalies (e.g., irregularities or issues) primarily rely upon supervised machine learning and statistical methods in an attempt to find and predict safety risks on project site. While such approaches may identify the presence of certain jobsite conditions, for example, people working on or near scissor lifts, these techniques largely end at simple classification of objects in an image. This limited scope often fails to capture more nuanced safety violations. These legacy technologies are generally unable to interpret context or assess the broader imaging scene.

Accordingly, there is a need for improved systems, devices, and methods for detecting, analyzing, and reporting project site safety conditions in a more efficient, expedited, and reliable manner.

### SUMMARY

Each of the aspects disclosed herein may include one or more of the features described in connection with any of the other disclosed aspects. Aspects of the disclosure may relate to systems, devices, and methods for automatically processing, analyzing, and describing source files of imaging data for construction progress tracking applications.

In an example, a computer-implemented method for monitoring safety of a project site may include receiving, at one or more processors communicatively coupled to an imaging system including one or more cameras, a set of unprocessed imaging data of a region of interest of the project site. The set of unprocessed imaging data may include a plurality of images captured by the imaging system. The computer-implemented method may further include processing, using an image processing model executed by the one or more processors, the unprocessed imaging data by deduplicating the plurality of images to generate a set of processed imaging data including one or more images, analyzing, using a vision large language model (LLM) executed by the one or more processors, the one or more images in the set of processed imaging data to identify a safety condition at the project site associated with at least one of (i) at least one physical structure or (ii) at least one project site state. The analyzing may include performing feature extraction to generate structured data representations of the one or more images. The analyzing may further include identifying a safety condition at the project site based on a relationship or label within the structured data representations, determining a semantic category corresponding to the safety condition via application of a transformer-based neural network to the safety condition, and generating a textual description that characterizes the identified safety condition present in the one or more images based on at least the semantic category corresponding to the safety condition.

Any of the systems, devices, and methods disclosed herein may include any of the following features. The one or more images each may include associated metadata, and the structured data representations may be generated further based on the metadata associated with the one or more images.

The computer-implemented method may further include transmitting, by the one or more processors, a safety standard request to a safety database server, receiving, by the one or more processors, a safety database response including safety standard data from the safety database server, and utilizing, by the one or more processors, the vision LLM to generate a safety report. The safety report may be based on at least one of the textual description or the safety standard data.

The safety standard data may include at least one standardized safety regulation.

The computer-implemented method may further include utilizing, by the one or more processors, the vision LLM to generate an analysis of the project site. The analysis may be based on the safety report.

The computer-implemented method may further include receiving, by the one or more processors, a data inquiry from a user device. The data inquiry may include at least one reference to a portion of the project site.

The computer-implemented method may further include utilizing, by the one or more processors, the vision LLM to generate a data response. The data response may be based on at least one of the safety report, the safety standard data, or the data inquiry.

The set of processed imaging data may be based on one or more source files that have had at least one of feature extraction, semantic segmentation, or edge detection applied by a preprocessing server.

The set of processed imaging data may include metadata including at least one of timestamp data, geolocation data, sensor data, lens data, photographic setting data, sensor calibration data, or sensor angle data.

The identification of the safety condition at the region of interest may be further based on the metadata.

The imaging system may include a 360-degree camera system or an unmanned aerial vehicle (UAV).

The deduplicating may include generating a plurality of bounding boxes. Each of the plurality of bounding boxes identifies (i) at least one physical structure or (ii) at least one project site state in a corresponding image of the plurality of images. The deduplicating may further include generating a plurality of rays. Each of the plurality of rays corresponds to a center of a corresponding bounding box of the plurality of bounding boxes. The deduplicating may further include determining that two or more generated rays intersect with one another. The intersection indicates that the bounding boxes corresponding to the two or more generated rays identify a same physical structure or a same project site state. The deduplicating may further include selecting a subset of the plurality of images to be the set of processed imaging data based on the determination that the two or more generated rays intersect with one another.

The imaging system may be configured to automatically capture, using the one or more cameras, a first image at a first time and a second image at a second time. An interval between the first time and the second time may be defined by the safety condition.

This disclosure may further include a system for automatically tracking safety conditions, the system may include one or more processors, and one or more non-transitory computer readable media storing instructions which, when executed by the one or more processors, cause the one or more processors to perform operations that may include receiving, from an imaging system that may include one or more cameras, a set of unprocessed imaging data of a region of interest of the project site. The set of unprocessed imaging data may include a plurality of images captured by the imaging system. The operations may further include processing, using an image processing model, the unprocessed imaging data by deduplicating the plurality of images to generate a set of processed imaging data including one or more images, analyzing, using a vision large language model (LLM), the one or more images in the set of processed imaging data to identify a safety condition at the project site associated with at least one of (i) at least one physical structure or (ii) at least one project site state. The analyzing may include performing feature extraction to generate structured data representations of the one or more images, identifying a safety condition at the project site based on a relationship or label within the structured data representations, determining a semantic category corresponding to the safety condition via application of a transformer-based neural network to the safety condition, and generating a textual description that characterizes the identified safety condition present in the one or more images based on at least the semantic category corresponding to the safety condition.

Any of the systems, devices, and methods disclosed herein may include any of the following features. The one or more images may each include associated metadata, and the structured data representations may be generated further based on the metadata associated with the one or more images.

The operations may further include transmitting a safety standard request to a safety database server, receiving a safety database response may include safety standard data from the safety database server, and utilizing the vision LLM to generate a safety report. The safety report may be based on at least one of the textual description or the safety standard data.

The safety standard data may include at least one standardized safety regulation.

The operations may further include utilizing the vision LLM to generate an analysis of the project site. The analysis may be based on the safety report.

In a further example, one or more non-transitory computer readable media for automatically tracking safety conditions, may store instructions which, when executed by one or more processors, cause the one or more processors to perform operations that may include receiving, from an imaging system may include one or more cameras, a set of unprocessed imaging data of a region of interest of the project site. The set of unprocessed imaging data may include a plurality of images captured by the imaging system. The operation may further include processing, using an image processing model, the unprocessed imaging data by deduplicating the plurality of images to generate a set of processed imaging data including one or more images, analyzing, using a vision large language model (LLM), the one or more images in the set of processed imaging data to identify a safety condition at the project site associated with at least one of (i) at least one physical structure or (ii) at least one project site state. The analyzing may include performing feature extraction to generate structured data representations of the one or more images, identifying a safety condition at the project site based on a relationship or label within the structured data representations, determining a semantic category corresponding to the safety condition via application of a transformer-based neural network to the safety condition, and generating a textual description that characterizes the identified safety condition present in the one or more images based on at least the semantic category corresponding to the safety condition.

Any of the systems, devices, and methods disclosed herein may may include any of the following features. The operations may further include transmitting a safety standard request to a safety database server, receiving a safety database response may include safety standard data from the safety database server, and utilizing the vision LLM to generate a safety report. The safety report may be based on at least one of the textual description or the safety standard data.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 depicts a diagram of an example system 100 for automatically analyzing and describing a set of source files of imaging data of a project site, according to aspects of this disclosure.

FIG. 2 depicts a diagram of example components of a device 200 that may execute the techniques described in the present disclosure.

FIG. 3 depicts an illustrated image of a project site captured by a device for use by the preprocessing server 140 of system 100, according to aspects of this disclosure.

FIG. 4A depicts a first illustrated and described image of a project site captured by a device of system 100, according to aspects of this disclosure.

FIG. 4B depicts a second illustrated and described image of a project site captured by a device of system 100, according to aspects of this disclosure.

FIG. 4C depicts a third illustrated and described image of a project site captured by a device of system 100, according to aspects of this disclosure.

FIG. 4D depicts a fourth illustrated and described image of a project site captured by a device of system 100, according to aspects of this disclosure.

FIG. 5 depicts a call flow between the various elements of system 100, according to aspects of this disclosure.

FIG. 6 depicts an example method performed by the safety server 130 for tracking and describing safety conditions, according to aspects of this disclosure.

FIG. 7 depicts an example clustering diagram corresponding to operations performed by the preprocessing server 140, according to aspects of this disclosure.

### DETAILED DESCRIPTION

As discussed in the background section, existing solutions for project site safety tracking may be expensive, time-consuming, or error prone. Such inefficiencies drive cost and delay throughout a project. Additionally, errors in safety anomaly recognition may result in hazardous conditions for workers.

Further, traditional computer vision and machine learning approaches to safety detection have generally focused on object recognition and scene segmentation (e.g., identifying what is present in an image or video, such as people, equipment, or environmental features). While these methods may detect the presence of potentially hazardous elements, these techniques lack the ability to infer contextual safety risks or reason through complex interactions (e.g., why something is unsafe).

As a result, legacy systems generally fall short in accurately identifying and describing unsafe behaviors or configurations. For example, a conventional model might detect a person and a scissor lift in a scene but may not be capable of determining whether the person's behavior—such as standing on the rails rather than the platform—is unsafe. In contrast, modern large language models (LLMs), particularly when enhanced through prompt engineering and logical reasoning frameworks, can interpret why a situation is dangerous.

To address the foregoing, the present disclosure provides methods and systems for automatically generating descriptions of safety conditions on a project site based on imaging data (e.g., unmanned aerial vehicle images and/or ground-based images) to detect and describe safety conditions by incorporating a logical reasoning-based approach using modern LLMs, with minimal dependence on supervised machine learning, statistical analysis, and simplistic labeling techniques. Using modern reasoning LLMs and prompt tuning techniques, the methods and systems in the present disclosure enable an automated safety detection system capable of fully understanding safety conditions and explaining why certain situations or behaviors captured in imaging data may be unsafe through logical reasoning. In this manner, the present disclosure provides a technical improvement in the field by enabling faster, more accurate, more descriptive, and more scalable detection of safety conditions (e.g., hazards, anomalies, potential violations, etc.) on a project site, thereby reducing both manual labor and data overhead typically needed for safety tracking and enabling provision of more comprehensive safety reports to users.

Moreover, the systems, devices, and methods of the disclosure may apply vision-based and multimodal large language models to imaging data to interpret project site imagery to systematically and automatically generate standardized safety descriptions (e.g., a safety condition report), which may be further augmented by integration with project site regulation databases. The approaches described herein may provide near-real-time safety insights, accelerate overall feedback loops for project stakeholders, and enhance the scalability of automated site monitoring.

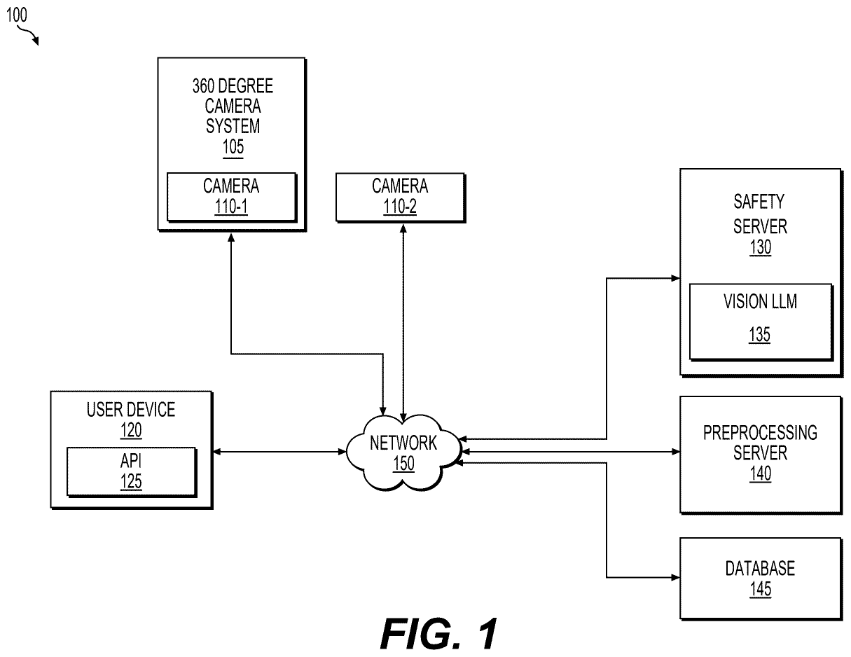

FIG. 1 is a diagram of an example system 100 for automatically analyzing and describing a set of source files of imaging data of a project site. As used herein, the term “project site” is broadly defined to include any physical location, area, or environment in which activities, processes, or operations related to a specific project, plan, or activity are performed, planned, monitored, or assessed. A project site may include, without limitation, construction sites, renovation or remodeling sites, infrastructure or development sites or zones, maintenance or repair sites, manufacturing or industrial sites, storage sites, staging sites, inspection sites, disaster recovery or remediation sites, environmental sites, and any other locations associated with project-related activities. Additionally, a project site may include both indoor and outdoor settings, permanent or temporary workspaces, mobile or fixed environments, as well as remote, distributed, or otherwise geographically dispersed locations.

As shown in FIG. 1, the system 100 may include a 360-degree camera system 105, a camera 110-1, a camera 110-2, a user device 120, an application programming interface (API) 125, a safety server 130, a vision LLM 135, a preprocessing server 140, a database 145, and a network 150.

The 360-degree camera system 105 may be any imaging system capable of capturing a panoramic or spherical field of view. Such camera systems may use multiple lenses and image sensors to record in multiple directions simultaneously, thereby providing a more complete understanding of the imaging scene compared to traditional cameras. In various embodiments, the 360-degree camera system 105 may be carried by or be otherwise affixed to a person (e.g., a handheld device). Alternatively, the 360-degree camera system 105 may be mounted in a fixed position, attached to a vehicle, unmanned aerial vehicle (UAV), robot, or integrated into other mobile platforms. While reference is made herein to 360-degree camera system 105, one of ordinary skill in the art will appreciate that various other imaging systems may be used alone or in combination with any of the systems, devices, and methods described herein.

In some aspects of the disclosure, the 360-degree camera system 105 may be replaced or used in conjunction with a UAV (e.g., a drone or any vehicle or machine that can be controlled remotely), which may include a device configured to fly above, around, within, etc., a region of interest. For example, the UAV may be a multi-rotor drone, a fixed-wing drone, a single-rotor drone, a vertical take-off and landing (VTOL) drone, a satellite, or the like. Alternatively or additionally, a ground-based device equipped with a camera may be used. For example, a vehicle or a robot with an integrated camera may be utilized either alongside or as an alternative to a UAV.

The camera 110-1 and/or the camera 110-2 may be a device configured to capture imaging data of a region of interest. For example, the camera 110-1 and/or the camera 110-2 may be a digital camera, a thermal camera, a hyperspectral camera, or the like. One of ordinary skill in the art will appreciate that various camera formats may also be used without departing from the scope of the disclosure. For example, a camera (or a device including a camera) may be held by, attached to, or otherwise affixed to a construction worker (e.g., a bodycam). In another example, a camera may be part of a virtual reality (VR), augmented reality (AR), or mixed reality (MR) headset. As previously noted, the camera 110-1 may be part of the 360-degree camera system 105. While the camera 110-1 is described as “a camera”, it will be understood that the camera 110-1 may comprise one or more cameras corresponding to the 360-degree camera system 105.

The systems, devices, and methods of the disclosure may utilize cameras of various formats or types. For example, safety reports may be based on imaging data contemporaneously generated by a camera implemented on a 360-degree camera system 105 (e.g., the camera 110-1), a camera held by a person, a bodycam, a vehicle or robot-mounted camera, and/or a fixed CCTV camera.

In some aspects of the disclosure, the user device 120 may be a device configured to receive a set of source files of imaging data corresponding to a region of interest captured by the camera 110-1, and/or the camera 110-2. For example, the user device 120 may be a smartphone, a laptop computer, a desktop computer, a server, or the like. In some aspects of the disclosure, the user device 120 may act as a relay between one or more camera devices and one or more servers. For example, the 360-degree camera system 105 (e.g., camera 110-1) may transmit imaging data and/or metadata to the user device 120. Such a relay implementation may be desirable in certain remote operating environments. In other aspects of the disclosure, the devices corresponding to cameras 110-1 and/or 110-2 may directly transmit payloads to the safety server 130 in a substantially similar manner as described with respect to the user device 120.

The API 125 may be an interface that permits the user device 120 and the safety server 130 to communicate. For example, the user device 120 (and/or the 360-degree camera system 105, camera 110-1, etc.) may provide a set of payloads to the safety server 130 via the API 125. The user device 120 may receive safety condition information from the safety server 130.

The safety server 130 may include a device configured to execute a vision large language model (LLM) to determine the presence (or lack thereof) of a safety issue or anomaly preprocessed imaging data, describe said safety issue in the imaging data, receive safety reference data from a database, and generate an updated safety description based on the reference data and the description of the safety issue, and transmit said descriptions to the user device 120. For example, the safety server 130 may be a server, a cloud server, a virtual machine, or the like.

The vision LLM 135 may include a model configured to receive a set of preprocessed imaging payloads as an input from a preprocessing server 140, to detect safety conditions (e.g., issues, hazards, or the lack thereof) in imaging data, describe safety conditions in the imaging data, receive safety reference data from a database 145, generate an updated safety description, and transmit said updated safety description to the user device 120 as one or more outputs. In an example, the vision LLM 135 may include a neural network. The vision LLM 135 may apply heuristics to consider the logical relationship of safety related objects on the project site. For example, the detection of accumulated sawdust may imply both a tripping hazard and a fire hazard.

The preprocessing server 140 may be a device configured to receive imaging payloads from various input sources, including unmanned aerial vehicles (e.g., 360-degree camera system 105, etc.), ground-based cameras (e.g., CCTV, bodycams, handheld 360-degree cameras, etc.), vehicle-mounted cameras, and other imaging devices. The preprocessing server 140 may organize, standardize, and process imaging payloads—including both image data and associated metadata—before transmitting the refined data to the safety server 130. The preprocessing server 140 may apply object detection or segmentation algorithms to label objects within image payload(s). For example, the preprocessing server 140 may identify and label a ladder in an image corresponding to an image payload.

The preprocessing server 140 may be a server, a cloud server, a virtual machine, or the like. While the preprocessing server 140, the database 145, and the safety server 130 are described herein as discrete elements, one of ordinary skill in the art will appreciate that in some aspects of the disclosure, these elements may be integrated into a single computing platform in various combinations.

The preprocessing server 140 may execute a series of data conditioning steps to optimize imaging payloads for efficient analysis by the safety server 130. These steps may include image format conversion, resolution normalization, geospatial alignment, noise reduction, and/or compression to ensure uniformity across various imaging devices. The preprocessing server may cluster imaging payloads based on various schema. A schema may define a particular set of metadata, a particular set of values of the metadata, a particular relationship between values of the metadata, particular thresholds, etc., that are used to cluster, classify, and/or validate the imaging payloads. Image clustering may include grouping images based on where they are located on a project site map, based on the image labeling. For example, a portion of the image may include a label “1^{st} Floor Elevator Shaft Entrance” and all such images including such a label may be clustered.

The preprocessing server 140 may extract, validate, and structure metadata such as timestamps, geolocation data, sensor data, lens data, photographic settings (including aperture, ISO, and/or shutter speed), sensor calibration data, and/or sensor angle (e.g., pitch, roll, and/or yaw). The preprocessing server 140 may apply one or more computer vision algorithms such as feature extraction, semantic segmentation, and/or edge detection to enhance image clarity and highlight key elements within a scene, such as structural components or material stockpiles. The preprocessing server 140 may apply these techniques to various types of imaging, including traditional optical (e.g., RGB), thermal (e.g., infrared), near-infrared, Light Detection and Ranging, (LiDAR), and other known imaging techniques, separately or in combination.

The preprocessing server 140 may apply machine learning algorithms to perform automatic image quality control. For example, the preprocessing server 140 may detect corrupted, blurry, or incomplete images that may otherwise compromise downstream analysis at the safety server 130. Once fully processed, the standardized imaging payloads are transmitted by the preprocessing server 140 to the vision LLM 135 of the safety server 130.

The database 145 may include a device configured to store source files, payloads, digital imaging assets, safety reference materials, and/or the like. For example, the database 145 may be a centralized database, a distributed database, a cloud database, a network database, a hierarchical database, or the like. Database 145 may be queried by the safety server 130 for various safety reference data. Safety reference data may be analyzed by the safety server 130 to generate more informative and relevant safety descriptions and summaries. Relevant safety reference data may include Occupational Safety and Health Administration (OSHA) standards, American National Standards Institute (ANSI) standards, ISO Standards (International Organization for Standardization) standards, National Fire Protection Association (NFPA) standards, and other various relevant standards, rules, best practices, guidelines, and regulations. One of ordinary skill in the art will appreciate that database 145 may include information and standards relevant to a given construction project. For example, construction of an offshore oil rig may entail certain maritime standards (e.g., those promulgated by the International Maritime Organization (IMO)).

Safety reference data may be linked or otherwise have a relationship with other safety reference data. For example, a first safety issue (e.g., fall hazards) may be linked to another safety issue (e.g., falling objects). For example, missing mid-rails and toe boards may create a fall hazard for workers on a scaffold. Such a condition may also create a struck-by-hazard condition for other workers below the scaffold. Such relationships may allow the safety server 130 to better estimate the impact and potential multi-factor risks in its safety descriptions.

The network 150 may be a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a satellite network, an air-to-ground network, future contemplated networking standards such as 6G, and the like, and/or a combination of these or other types of networks.

The number and arrangement of the devices of the system 100 shown in FIG. 1 are provided as an example. In practice, the system 100 may include additional devices, fewer devices, different devices, or differently arranged devices than those shown in FIG. 1. Additionally, or alternatively, a set of devices (e.g., one or more devices) of the system 100 may perform one or more functions described as being performed by another set of devices of the system 100.

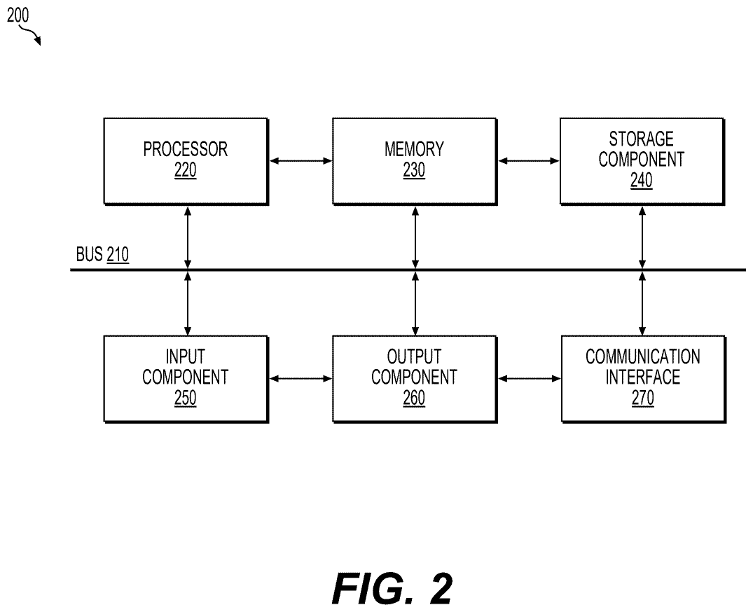

FIG. 2 is a diagram of an example device that may execute the techniques described herein. The device 200 may correspond to the 360-degree camera system 105, the camera 110-1, the camera 110-2, the user device 120, the safety server 130, the preprocessing server 140, and/or the database 145. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 may be implemented in hardware, firmware, or a combination of hardware and software. In some aspects, processor 220 may include specialized cores optimized for parallel processing or machine-learning tasks. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component.

The processor 220 may include one or more processors capable of being programmed to perform a function. The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone for receiving the reference sound input). Additionally, or alternatively, the input component 250 may include a sensor for sensing information (e.g., a global positioning system (GPS) component, an accelerometer, a gyroscope, and/or an actuator). The output component 260 may include a component that provides output information from the device 200 (e.g., a display, a speaker for outputting sound at the output sound level, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes based on the processor 220 executing software instructions stored by one or more non-transitory computer-readable media, such as the memory 230 and/or the storage component 240. A computer-readable medium may be defined herein as a non-transitory memory device. A memory device may include memory space within a single physical storage device or memory space spread across multiple physical storage devices.

The software instructions may be read into the memory 230 and/or the storage component 240 from another computer-readable medium or from another device via the communication interface 270. When executed, the software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of the components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

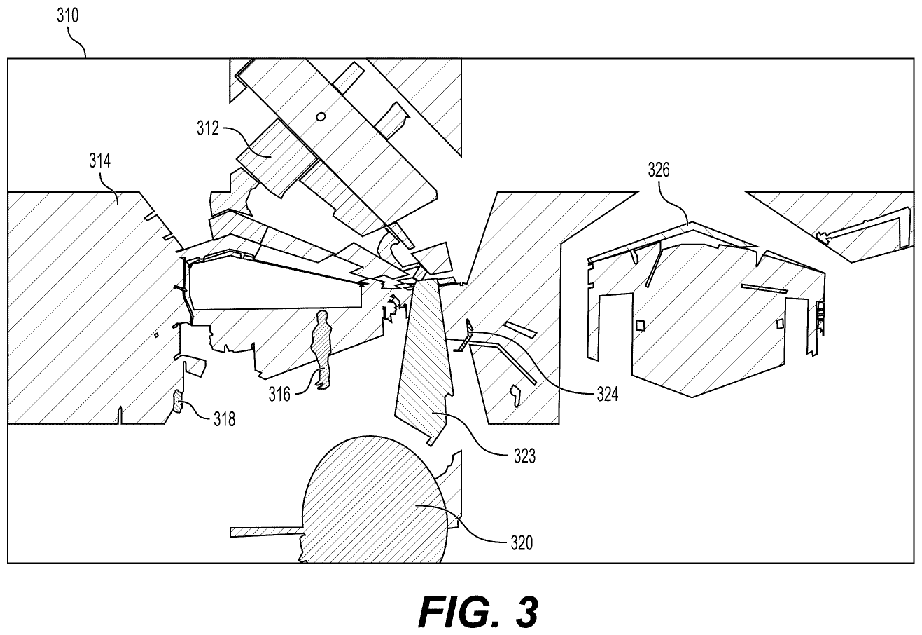

FIG. 3 depicts an illustrated image of a project site captured by an unmanned aerial vehicle (or any other device/system including a camera) for use by the preprocessing server 140 of system 100, according to aspects of this disclosure. The image shown in FIG. 3 may be an intermediary step or process between raw imaging data and a finalized safety description corresponding to the raw imaging data.

As shown in FIG. 3, an imaging scene 310 depicts a portion of the project site. The imaging scene 310 includes several notable imaging landmarks, such as an HVAC 312, finishes 314, a person 316, a fire extinguisher 318, a camera holder 320, a ladder 323, a stocked material 324, and an electrical system 326. The preprocessing server 140 may receive imaging data from a camera, such as camera 110-1. The preprocessing server 140 may apply one or more object detection algorithms to the imaging data. For example, the preprocessing server 140 may identify and label the aforementioned imaging landmarks in the imaging data as part of one or more imaging data preprocessing operations.

One of ordinary skill in the art will appreciate that various objects, items, people, landmarks, locations, and materials may be recognized in the imaging scene and that reference above to any specific imaging landmark is for explanatory purposes.

The aforementioned labeled imaging data may be detected and described by the safety server 130, further description of which is provided below. While FIG. 3 shows object identification and labeling in an indoor space, one of ordinary skill in the art will appreciate that the systems, devices, and methods described herein may be applicable to any part of a project site. For example, system 100 may observe safety conditions to a building exterior, earthwork, aesthetic elements, and the like.

It is to be understood that the view shown in FIG. 3 with the labeled landmark objects (e.g., the HVAC 312, the finishes 314, the person 316, the fire extinguisher 318, the camera holder 320, the ladder 323, the stocked material 324, and the electrical system 326) is presented merely as illustrative examples of the types of site objects that may be detected and described by the systems, devices, and methods of the disclosure. As such, the disclosed embodiments are not limited to any particular set of construction tasks, materials, or site conditions, and may be adapted to any number of other industrial, commercial, or residential construction processes.

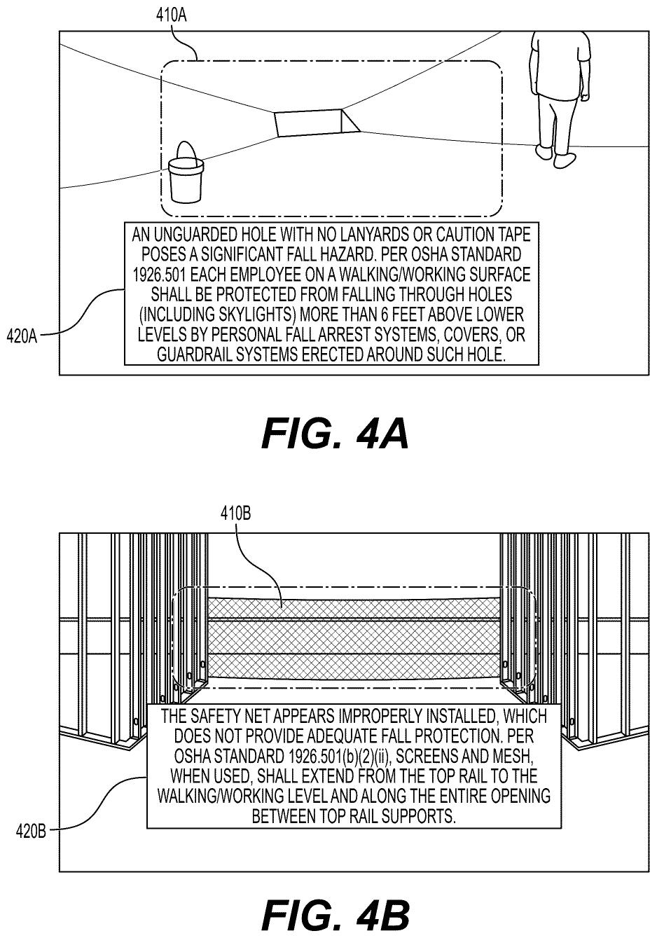

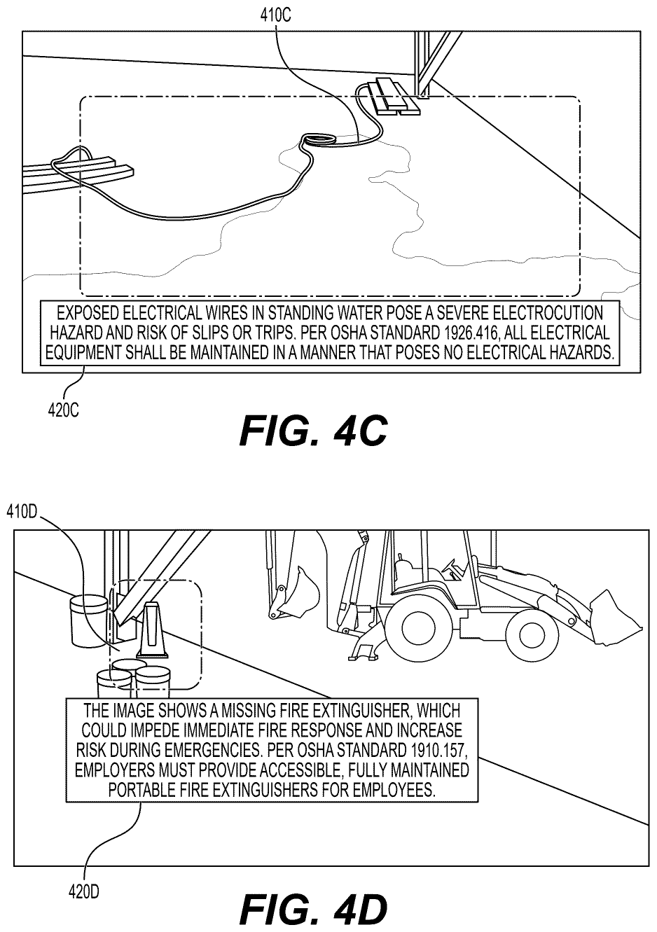

Image capture operations for safety monitoring may vary. For example, the time intervals and frequency of capture for the imaging data (e.g., images, videos, or other sensor readings) may be selected or modified to suit the specific demands of different projects. In some instances, a daily capture schedule may be beneficial for rapidly progressing tasks, while more extended intervals may suffice for slower-moving or less critical activities. In some aspects, different capture technology may be applied at different times of day. For example, the 360-degree camera system 105 may be deployed twice daily, in the morning (to capture RGB optical imaging) and in the evening (to capture infrared imaging). Both such captures may be utilized by system 100 to generate one or more safety descriptions. Multiple example safety descriptions are provided in FIGS. 4A-4D.

While FIG. 3 highlights indoor site safety analysis, the disclosed systems, devices, and methods may similarly be applied to outdoor areas, infrastructure projects, renovation sites, excavation and earthworks, equipment staging, or any other environment where it is desirable to automatically monitor safety conditions. Hence, the embodiments described herein are neither limited to new construction projects nor limited to any single project type.

FIGS. 4A-4D depict various illustrated and described images of a project site captured by an unmanned aerial vehicle (or any other device/system including a camera) of system 100, according to aspects of this disclosure. FIGS. 4A-4D illustrate various described safety issues as identified by the safety server 130. As described in FIG. 3, various objects may be recognized and labeled by the preprocessing server 140. The processed imaging data may then be transmitted to the safety server 130 for description and analysis by the vision LLM 135. The safety server 130 may request further relevant safety reference information from the database 145 when generating and/or updating its descriptions of the imaging data.

FIG. 4A shows a project site with an identified hole 410A. The safety server 130 may determine that the hole is unguarded (e.g., without lanyards or caution tape), creating a fall or drop risk. This information may form the basis for an initial description of the scene shown in FIG. 4A. The safety server may then query the database 145 for relevant safety regulations to update the initial description with relevant regulatory safety regulations (e.g., OSHA standard 1926.501), to generate an updated description 420A.

FIG. 4B shows a project site with an identified building edge 410B. The safety server 130 may determine that the building edge is without proper safety netting, creating a fall risk. This information may form the basis for an initial description of the scene shown in FIG. 4B. The safety server may then query the database 145 for relevant safety regulations to update the initial description with relevant regulatory safety regulations (e.g., OSHA standard 1926.502(b)(2)(ii)), to generate an updated description 420B.

FIG. 4C shows a project site with identified electrical wires and water puddle 410C. The safety server 130 may determine that the electrical wiring running through the water is creating an electrocution risk. This information may form the basis for an initial description of the scene shown in FIG. 4C. The safety server may then query the database 145 for relevant safety regulations to update the initial description with relevant regulatory safety regulations (e.g., OSHA standard 1926.416), to generate an updated description 420C.

FIG. 4D shows a project site with identified fire control station 410D. The safety server 130 may determine that a missing fire extinguisher from the fire control station 410D is creating a fire risk. This information may form the basis for an initial description of the scene shown in FIG. 4D. The safety server may then query the database 145 for relevant safety regulations to update the initial description with relevant regulatory safety regulations (e.g., OSHA standard 1910.157), to generate an updated description 420D.

One of ordinary skill in the art will appreciate that the various examples of safety hazards and corresponding regulations described above are only exemplary. Any references made to specific structures, materials, or components on a project site are provided solely for purposes of clarity and example. Any references made to specific regulations, rules, standards, suggested best practices, and the like are provided solely for purposes of clarity and example.

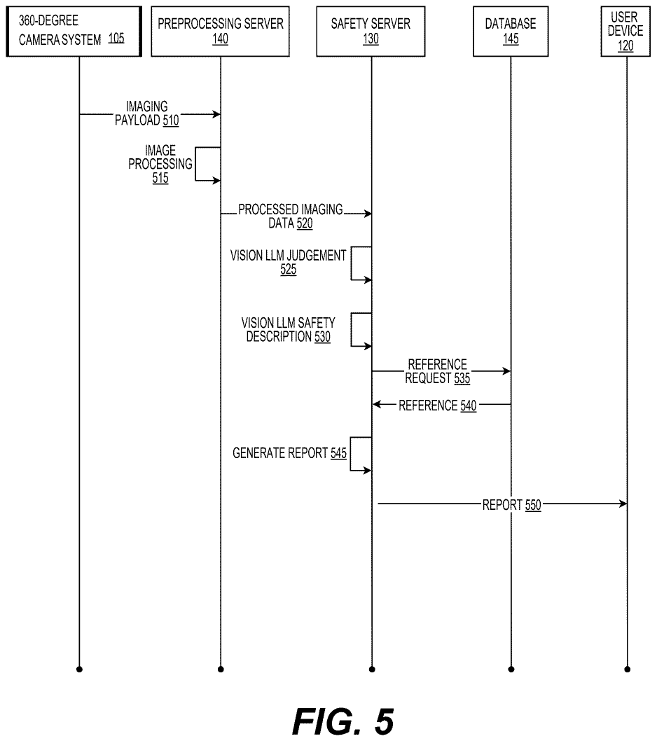

FIG. 5 shows a call flow diagram of the system 100, according to aspects of the disclosure. The call flow depicted in FIG. 5 depicts a sequence of operations and communications between 360-degree camera system 105, preprocessing server 140, safety server 130, database 145, and user device 120. It should be understood that while preprocessing server 140, safety server 130, database 145, and user device 120 are shown and described herein as discrete elements of system 100, these elements may be included alone or combination with one another into a single system. For example, in some aspects, preprocessing server 140 and safety server 130 may each be part of the same system.

At step 510, the 360-degree camera system 105 may transmit an imaging payload to the preprocessing server 140. The imaging payload may include one or more imaging data, video data, and/or metadata. Each of the source files may include various metadata. For example, the metadata may include a latitude, a longitude, an altitude, a time stamp, an identifier of the camera 110, an identifier of the 360-degree camera system 105, a number of pixels, a pixel height, a pixel width, an aspect ratio, a file type, a flight identifier, a job identifier, a region of interest identifier, an entity identifier, an operator identifier, a user identifier, a customer identifier, geolocation data, sensor data, lens data, photographic settings (including aperture, ISO, and/or shutter speed), sensor calibration data, and/or sensor angle (e.g., pitch, roll, and/or yaw).

The preprocessing server 140 may, in some aspects, receive (or download) only necessary data such as keyframes, segmentation masks corresponding to a project site walkthrough, and the cameras file. A keyframe may refer to a representative frame extracted from a video or image sequence that captures a distinct view of the project site, typically selected for its relevance or clarity in analysis. In some aspects, segmentation masks may differ in resolution from the keyframes.

Imaging data generated by the 360-degree camera system 105 may be taken from multiple locations, perspectives, angles, and fields of view. For example, a first image in the imaging data may be taken from an interior perspective showing an unfinished wall, and a second image in the imaging data may be taken from an exterior perspective of the same unfinished wall. In some aspects, some of the imaging data may not be relevant from a safety analysis perspective to other portions of the imaging data. For example, a third image in the imaging data may be of exposed wiring in a closet. It should be understood that the preprocessing server 140 may be configured to cluster images by imaging subject (e.g., grouping the first and second images together, without the third image). In some aspects, however, the third image (which may not be directly relevant to the safety analysis of the first and second images mentioned above) may still be provided to the safety server 130 and may be determined to be less relevant (or irrelevant) to a given safety analysis by the safety server 130. For example, if the safety server 130 is configured to describe only certain safety issues, the safety server 130 may ignore imaging data that is irrelevant to the certain safety issues.

Imaging data included in the imaging payload may be generated by the 360-degree camera system 105 (e.g., via camera 110-1), including traditional optical (e.g., RGB), thermal (e.g., infrared), near-infrared, Light Detection and Ranging, (LIDAR), and other known imaging techniques. One of ordinary skill in the art will appreciate that while the 360-degree camera system 105 is shown in FIG. 5 as the entity providing imaging payloads to the preprocessing server 140, this is only exemplary. For example, a different type of camera (and/or any additional camera(s)) may complement or replace the 360-degree camera system 105 in some aspects of the disclosure. In such examples, the additional camera(s) may each transmit imaging payloads of a similar scene of a project site (e.g., similar to FIGS. 3 and 4A-4D).

In some aspects of the disclosure, imaging may be generated at a rate based on the severity of previously determined safety issues. For example, if a previously generated safety description rated an issue as “severe,” the system 100 may deploy follow-up imaging at a more rapid (e.g., different, or otherwise changed) rate to more frequently analyze and report on the safety condition.

In step 515, the preprocessing server 140 may perform one or more image processing operations. Image processing may include optimization of imaging data received from the 360-degree camera system 105 (e.g., from step 510). The preprocessing server 140 may execute a series of data conditioning steps to optimize imaging payloads for efficient analysis by the safety server 130. These one or more steps may include image format conversion, resolution normalization, geospatial alignment, noise reduction, and/or compression to ensure uniformity across various imaging devices.

The preprocessing may include detection of contours of objects of interest (e.g., ladders) identified within segmentation masks. Contours outline the shape of a detected object. In some cases, raw contours may be noisy or fragmented. Accordingly, the preprocessing server 140 may merge nearby contours before generating a final bounding box around the detected object. A bounding box is a rectangular outline that surrounds an object detected in an image. Bounding boxes may define the location and size of an object. A center of each bounding box may define one end of a ray originating the camera at the time, location, and angle of the image capture.

The preprocessing server 140 may also cluster imaging payloads based on various schema. A schema may define a particular set of metadata, a particular set of values of the metadata, a particular relationship between values of the metadata, particular thresholds, etc., that are used to cluster, classify, and/or validate the imaging payloads. Image clustering may include grouping images based on where they are located on a project site map, based on the image labeling. For example, a portion of the image may include a label “1^{st} Floor Elevator Shaft Entrance” and all such images including such a label may be clustered.

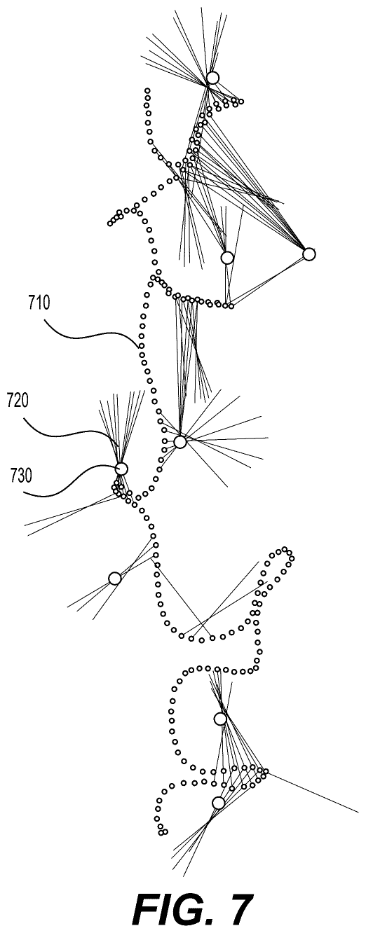

Clustering may also include the aforementioned rays corresponding to bounding boxes. Discussion will now move to FIG. 7, which shows a camera position path 710. Each dot of the camera position path 710 corresponds to a position of a camera (e.g., the camera 110-1) at a different moment in time. For example, the camera position path 710 may correspond to a user walking through a project site with the 360-degree camera system 105 to generate imaging data for system 100. A plurality of rays 720 are shown in FIG. 7. Each ray corresponds to a captured imaging frame (e.g., one or more photos or frames of a video) taken at a different position along the camera position path 710. The captured imaging data may include precise location, frame, camera settings, angle metadata, and the like.

As noted previously, each ray may correspond to a center of a bounding box around a detected object. With this information, the preprocessing server 140 may determine that objects detected in multiple images are actually a same object captured from different perspectives or vantage points. Each image of a same object generates a bounding box and corresponding ray that may intersect with one or more other rays of the same object. One such intersection point is shown in FIG. 7 at intersection 730 (represented by a dot), but other rays and intersections are also shown in FIG. 7. Accordingly, the system 100 (e.g., the preprocessing server 140) may determine that intersecting rays represent the same object. For example, if five images taken from different perspectives or vantage points show a ladder, but all rays corresponding to those images intersect, the preprocessing server 140 may determine (e.g., deduplicate) that there is only one ladder, and not five. Accordingly, the preprocessing server 140 may cluster these images into a group (associated with a particular location within the project site), since these images represent a same object, based on the intersection of the rays corresponding to the images. In some embodiments, only a subset (e.g., one or more) of images in each cluster may be used for the detection of safety conditions. Therefore, the clustering operation may reduce data use, processing time, or energy consumption of the various elements of the system 100 associated with safety condition detection.

Now with renewed reference to FIG. 5, clustering of imaging data may simplify the processing by both preprocessing server 140 and/or the safety server 130 to identify various objects and determine their relative locations for downstream processing and safety description generation. In the previous example, clustered images with “1^{st} Floor Elevator Shaft Entrance” label may increase the relevance of the images to regulations related to elevators, for example, and decreases (or eliminates) the relevance of the images to regulations related to objects or structural elements that cannot be present at the given location, such as regulations related to roofing.

Upon receiving raw imaging payloads from the 360-degree camera system 105, the preprocessing server 140 may validate image integrity, and check for corrupted images (and/or discard such corrupted images), missing metadata, and inconsistent formats. The preprocessing server 140 may adjust the image payloads by correcting lens distortions, adjusting white balance, and standardizing resolutions. To align before-and-after images, the preprocessing server 140 may apply feature-based matching to correct perspective differences between images. Noise reduction techniques may be applied to images to enhance clarity. The preprocessing server 140 may apply object detection or segmentation algorithms to label objects within image payload(s). The preprocessing server may apply a variety of computer vision techniques, such as Segment Anything Model (SAM2). In an example, the preprocessing server 140 may identify and label a ladder in an image corresponding to an image payload (e.g., similar to the labeled objects shown in FIG. 3). Image segmentation may enable the system 100 to differentiate between background objects and relevant safety-related objects, such as structural components, equipment, or personnel.

The preprocessing server 140 alternatively or additionally may determine one or more best frames from the imaging data to ensure only those informative or relevant frames are provided to the safety server 130. The preprocessing server 140 may analyze multiple frames of the imaging and/or video data and select the frame(s) with the clearest and least obstructed view of safety-related objects (e.g., structure, equipment, or personnel). Selected frame(s) may then be used for further processing at the preprocessing server 140 and/or may be transmitted to the safety server 130.

In step 520, the preprocessing server 140 may transmit the processed imaging data corresponding to imaging payloads 505 and 510 to the safety server 130. In some aspects, a backend system may be configured to manage the invocation and processing of safety workflows based on user-specific feature flags. These feature flags may include: (1) a flag to automatically initiate safety processing for each new generated map (e.g., a map and associated imaging data such as that shown in FIG. 7), (2) a flag to enable on-demand safety processing via a user interface element (e.g., on the user device 120), and (3) a flag to control user access to the final safety output (e.g., the report 550). Additional project-level toggles may be used to enable or restrict access to safety functionality at the organizational or project scope level.

Upon completion of a walkthrough alignment process (e.g., image processing 515), the safety server 130 may automatically check the relevant flags and, if conditions are met, trigger the creation of a safety machine learning job. This safety job may be initiated through a map handler service, which listens for data updates and invokes the appropriate job creation logic. Once processing is complete, the safety server 130 may send a completion notification and record the outcome. In cases of failure, an orchestration service may be used to capture and report the error.

In step 525, the safety server 130 may execute one or more operations using the vision LLM 135 to analyze the preprocessed imaging data received during step 520. The safety server 130 may take the preprocessed imaging data (e.g., including object labels and/or metadata) and make an initial determination of the presence (or lack thereof) of a safety issue in the imaging data via computer vision techniques such as feature extraction and one or more deep learning models. The determination may be an initial binary determination whether the scene in a given imaging data (e.g., a frame) is safe or not. The safety server 130 may also identify one or more safety conditions based on the labels applied to the imaging data by the preprocessing server 140. Features extracted may include shapes, textures, edges, colors, or higher-level structures (e.g., a roof, a window, a door). The output of the feature extraction may be a structured data representation (e.g., numerical vectors) that capture essential visual information from the imaging data (e.g., including label(s) for detected objects or other features/characteristics in the image(s), indication(s) of a presence of a safety condition, label(s) indicative of the image's cluster, metadata, etc.). These structured data representations may be utilized by further downstream steps.

In scenarios in which the safety server 130 receives multiple images, the safety server 130 may execute one or more algorithms to determine agreement among the various image frames. For example, if two images are of different scenes and objects, the safety server 130 may recognize that two descriptions need to be generated (e.g., one description for each of the different image frames). The safety server 130 may recognize and understand the context of an entire imaging scene. For example, the safety server 130 may determine the relationships between the various objects and location of a scene. Using FIG. 3 as an example, the safety server 130 may determine that person 316 is nearby and looking towards fire extinguisher 318. Continuing the example, the safety server 130 may determine that HVAC 312 is above the person 316.

In some aspects, the safety server 130 may determine a safety issue in an [object]+[context] format. One example includes [person]+[not wearing PPE]. Other examples include: [electrical cable]+[running through water], [ladder]+[placed near unsecured materials], [fire extinguisher stand]+[missing fire extinguisher], and [leading edge]+[no safety railing].

In some aspects, objects may correspond to a class. For example, all identified ladders and ladder issues may correspond to a “ladder” class. The safety server 130 may determine that an identified object corresponds to a class. Some examples related to ladders may include [ladder]+[too close to construction equipment], [ladder]+[not maintaining three-point contact], [ladder]+[placed near unsecured materials], [ladder]+[not secured in high-traffic area], [ladder]+[unsafely positioned], and [ladder]+[on snowy surface].

In some aspects, the safety server 130 may be configured to only generate descriptions on a per-type basis. For example, the safety server 130 may be configured to exclusively generate descriptions pertaining to fire extinguishers or ladders and exclude descriptions of scissor lifts, despite potentially all of these elements being present in a given imaging payload.

The safety server 130 may also determine that the scene shown in a given image may correspond to a specific location of the project site. In the example of FIG. 3, the safety server 130 may determine that the image corresponds to a southwesterly view from northeastern corner of a lobby of a third flood of a building. One of ordinary skill in the art will appreciate that the aforementioned locations are only exemplary and that the system 100 may identify any object or location at a project site.

As mentioned above, step 525 may also include a determination of where the image payload(s) are located (e.g., where the image payload is captured) on a project site. For aerial imagery, the image payloads may be determined to be within a predefined UAV boundary. For ground imagery, the location of the scene relative to the minimap may be extracted. The safety server 130 may perform deduplication/on imaging payloads to select best image frame(s), if multiple image pairs are determined to be located at the same location. The safety server 130 may perform deduplication by identifying instances of the same object as it appears in different frames captured during a single session. These frames may be recorded within seconds or minutes of each other, providing multiple viewpoints of a same scene rather than representing a “before and after” comparison. The image capture process typically utilizes ground-based 360-degree imaging (e.g., camera 110-1), where the same object can be observed from varying vantage points. To perform deduplication across these frames, a machine learning algorithm may be used in conjunction with the intersection technique described in reference to FIG. 7, to accurately recognize and consolidate duplicate objects viewed from different perspectives, and to select the best image frame from which a safety condition may be detected. Additional metadata as well as other sources such as a site minimap (including location names), blueprints, and predefined material categories may be referenced from the imaging payloads to determine where (e.g., minimap location, project, building, level, area) on the project site the imaging payloads were taken.

The safety server 130 (e.g., vision LLM 135) may analyze the image or set of images holistically and make a judgement and/or determination of whether a safety issue or risk condition is present in the imaging data. The judgment step may be customized to align with a user's specific preferences or to comply with applicable local, regional, or national safety standards. For instance, certain users may enforce stricter requirements regarding personal protective equipment, such as mandating the use of safety glasses with side-shields to protect against lateral exposure to flying debris or chemicals on a project site. Conversely, other users may adopt a more relaxed approach, potentially making the use of safety glasses entirely optional. This flexibility allows the system 100 to adapt its evaluation criteria to varying safety policies and enforcement levels.

The safety server 130 may apply its understanding of the imaging data—together with any additional context or metadata—to determine if there is anything in the scene that violates safety standards (for example, lack of guard rails, individuals using equipment incorrectly, etc.). The outcome of this step is a determination (or set of determinations) about potential hazards, which the safety server 130 may use in the subsequent step 530 for generating a descriptive explanation of any identified issues.

In some instances, the safety server 130 may determine that no safety issues are present, and the call flow may terminate. In other instances, the call flow may continue, with the ultimate description being that no issues were determined to be present in the imaging data. In the exemplary call flow of FIG. 5, it is assumed that one or more safety issues are determined to be present (e.g., similar to FIGS. 4A-4D).

After determining that safety issues are present, the safety server 130 may generate a list of detected safety issues corresponding to associated portions of the imaging data. It should be noted that the safety issue may not just be a single present hazard, but may alternatively or additionally comprise multiple hazards, a relation of hazards, and/or the absence of an object or person. The safety server 130 may also determine a semantic category corresponding to the safety issue or condition via application of a transformer-based neural network (e.g., the vision LLM 135) to the safety condition. For example, a determined missing handrail may correspond to a determination of a “fall-risk” as a semantic category.

In step 530, the safety server 130 may generate, using the vision LLM 135, structured, natural-language descriptions of the determined safety issues in step 525. Step 530 may translate image-based safety data, including the semantic category, into standardized and qualitative textual descriptions. At this point in the call flow, the descriptions may lack reference to specific safety standards. For example, the safety server 130's description of FIG. 4A may be “An unguarded hole with no lanyards or caution tape is present on the first floor.” The descriptions may be generated based on the determined semantic category. The determined semantic category may also be part of the generated textual description. For example, the aforementioned unguarded hole may be described as a “fall-risk.” The safety server 130 may also reference metadata in the processed imaging data during step 530. For example, the safety server 130 may note the absence of necessary lighting in an image based on the metadata indicating the image was captured after sunset (e.g., based on a timestamp).

In step 535, the safety server 130 queries the database 145 to retrieve relevant safety reference data corresponding to the detected safety issues identified in the step 525. The safety server 130 may query the SQL safety reference database 145, which may store structured information about various relevant safety standards such as Occupational Safety and Health Administration (OSHA) standards, American National Standards Institute (ANSI) standards, ISO Standards (International Organization for Standardization) standards, National Fire Protection Association (NFPA) standards, and other various relevant standards, rules, best practices, guidelines, regulations, and customized standards, any of which may be applicable to various countries, states, localities and organizations.

The database 145 may also include the project's planned activities, including information such as activity ID, activity name, start date, finish date, location ID, and building level (if applicable). The database 145 may also include a project-specific Primavera P6 schedule, which may itself include activity IDs & names, work breakdown structure (WBS), start & finish dates, task dependencies & relationships, resource assignments, critical path method (CPM) analysis, baseline tracking (e.g., early, on time, and late), and milestones. Such information may allow the safety server 130 to identify hazards based on scheduling and personnel data. For example, the safety server 130 may determine that a given supervisor should be present when a certain construction activity is underway, and that the absence of such a supervisor is itself a safety issue.

In step 540, the database 145 may provide the relevant project safety reference data to the safety server 130. The textual summaries generated may include standardized descriptions, including terminology and citations from standards organization and reference materials. The database 145 may also provide to the safety server 130 one or more previous relevant safety descriptions and/or reports.

In step 545, the safety server 130 may generate an updated safety description (e.g., report). The safety server 130 may analyze relevant safety reference data received during step 540 and may compare the safety issues described in step 530 against the safety reference data. The safety server 130 may evaluate the actual safety issue (e.g., referring to a specific portion of a specific standard) and may include such a citation in its description. The safety server 130 may also classify the safety issue by severity in a standardized manner (e.g., 1-5) which may allow stakeholders to prioritize more pressing safety issues. A standardized severity model may be developed and deployed with the system 100 based on user feedback or internal assessments of what level of response is appropriate to effectively balance risk mitigation with project staff time management. A standardized severity model may allow users to set responses for different types of safety or compliance issues. The standardized severity model may be also modified, allowing users to define and implement custom severity hierarchies tailored to specific needs, policies, or risk tolerance. The updated safety description may also reference previous relevant descriptions, for example, to note the worsening (or any other change) of a given safety condition that was previously analyzed by the safety server 130.

The safety server 130 may automatically flag or indicate potential safety issues in the updated safety description or report. In an example, the safety server 130 may have initially described (during step 530) a missing handrail on a staircase. When the safety server 130 retrieves the safety reference data in operation 440, the safety server 130 notes that the aforementioned safety issue corresponds to a certain potion of the retrieved safety reference data. The safety server 130 may then classify the issue and cite the relevant portion of the safety standard in the safety description. The systems, devices, and methods and the disclosure thus integrate safety reference data with automated safety condition tracking to generate timely and relevant safety descriptions and/or reports. In some aspects of the disclosure, a user may use a “chat” functionality on user device 120 to query safety information from the progress server 130 and vision LLM 135 in a natural-language format. The user may inquire whether a given safety issue has been rectified, for example. The safety server 130 chat responses may be based on safety reports, safety standards, and the user inquiry, or any combination thereof.

In step 550, the safety server 130 may transmit the generated safety descriptions and/or reports to the user device 120. As previously noted, the user device 120 may be a smartphone, computer, server, etc. A user may then view the generated safety report.

In some aspects of the disclosure, the call flow shown in FIG. 5 may terminate upon delivery of the generated safety descriptions to the user device 120 in step 550. In some aspects of the disclosure, additional steps may follow step 550, such as generation of analytics.

In some aspects, following step 550, the safety server 130 may generate analytics. The generated analytics may be based at least in part on the safety report and/or generated safety descriptions for a currently identified safety issue and/or any previously described safety issue. The generated analytics may include safety site analytics to measure safety issues, severity of issues, time to rectify issues, types of issues, location of issues, workers associated with issues, etc. This information may allow users to identify safety trends, adjust corrective measures, and allocate safety resources more efficiently. The safety server 130 may also generate enterprise analytics to analyze multiple projects, compare performance, detect trends, and highlight recurring safety issues across a broader construction portfolio. Safety server 130 may then provide the generated analytics to the user device 120.

A chat function may provide a user with an interactive means to query safety descriptions and safety reports without manually searching through descriptions or reports. This feature may enable users to ask real-time questions about, for example, safety issue rectification, ongoing safety issues, means of rectifying safety issues, historical safety issues, analogous safety issues, personnel in violation of safety protocol, and severity of safety issues. While the term “chat” is primarily used herein to describe a traditional LLM text-based chatbot, one of ordinary skill in the art will appreciate that “chat” may also refer to voice chat as well.

A user (e.g., via user device 120) may query the safety server 130 with a chat inquiry pertaining to at least a portion of the project site. For example, a user may ask “What are the known safety issues on the work site?” or “Has the unguarded hole on the second floor been rectified?” or “What is the relevant regulation to the ongoing electrical issue in the basement?” The safety server 130 may retrieve relevant data from a previously generated safety report or may itself query database 145 for information. In some aspects, the safety server itself may query or instruct 360-degree camera system 105 to generate new imaging of the queried location or to perform a predetermined imaging routine for use by system 100 (e.g., for use in the call flow shown in FIG. 5). The safety server 130 may then generate a structured response to the inquiry based on the safety reports (and/or descriptions), safety data (e.g., regulatory data pulled from database 145), and/or the query. The response may itself include a reference to the portion of the project site included in the data inquiry.

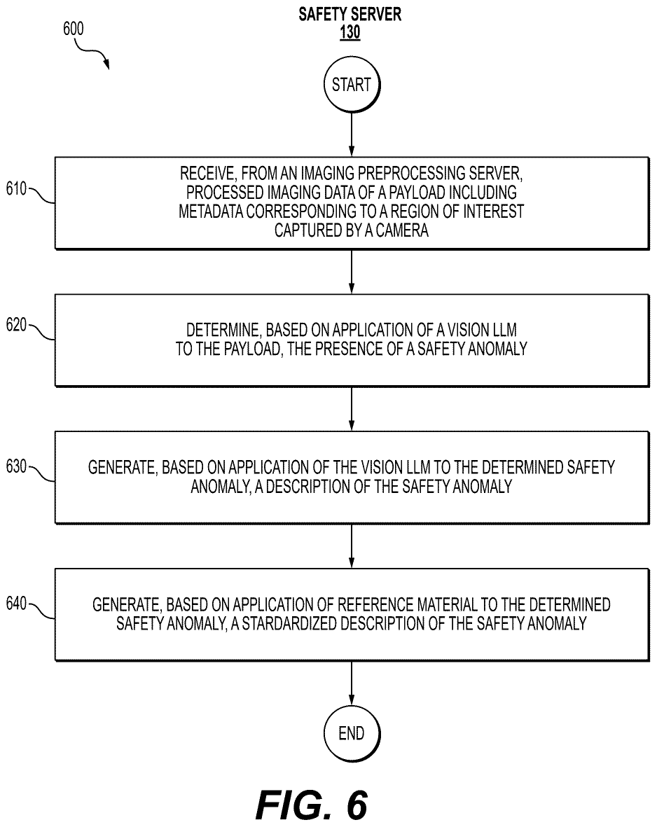

FIG. 6 depicts an example method performed by the safety server 130 for tracking construction safety conditions, according to aspects of this disclosure. The data flow described in FIG. 6 thus corresponds to the steps performed by the safety server 130 described in reference to FIG. 5. In step 610, the safety server 130 may receive processed imaging data from the preprocessing server 140. The processed imaging data may include a payload(s), which corresponds to video and/or imaging at the project site (e.g., at a region of interest). The payload may contain image/video data, metadata, and other sensor data captured by the UAVs, ground-based cameras, or other imaging devices.

In step 620, the safety server 130 applies a vision LLM (e.g., the vision LLM 135) to the payload to identify the presence of a safety anomaly (e.g., safety issue, safety violation, safety problem) in the image payload. The safety server 130 may apply a vision LLM that compares visual elements, such as structural modifications, material installations, personnel movement, and equipment movement (and/or the lack thereof). Further examples may include personnel use of equipment (such as ladders or scissor lifts), the presence or absence of certain equipment or portions thereof (e.g., fire extinguisher pedestals without the fire extinguishers), and material storage conditions (such as materials stored within six feet of an elevator shaft opening or the edge of a building). The safety server 130 may detect safety anomalies by leveraging pixel-wise differencing, feature matching, and/or semantic segmentation. The safety server 130 may, using the vision LLM 135, distinguish between pressing safety issues (e.g., exposed wiring in standing water) and less dangerous issues changes (e.g., a loose item laying on a walkway), ensuring that more important safety issues are captured and prioritized.

In step 630, the safety server 130 may generate a structured description of the detected safety issue via the vision LLM 135. The safety server 130 may describe the detected safety issue in relevant natural-language text descriptions. For example, if a worker is determined to not be wearing a hard hat, the safety server 130 may generate a description such as “Worker X is not wearing a hard hat while walking near an active crane.” The descriptions and summaries may be used downstream for reports and analytics.

In step 640, the safety server 130 may update the generated description from step 530 with relevant safety reference information retrieved from the database 145, based on the application of relevant safety reference data to the determined safety anomaly. For example, the previously noted example may be updated to recite “Worker X is not wearing a hard hat while walking near an active crane. Per OSHA 1910.135(a)(1)—‘The employer shall ensure that each affected employee wears a protective helmet when working in areas where there is a potential for injury to the head from falling objects’.”

In this way, the present disclosure provides methods and systems for automatically detecting, describing, and contextualizing safety issues in construction imaging data. The present disclosure provides a technical improvement in tracking and analyzing construction imaging data by more accurately and quickly detecting safety issues, more efficiently processing imaging data, and generating safety descriptions in real-time or near real-time. Moreover, the present disclosure enables safety condition tracking using metadata and structured analysis rather than requiring full manual review of image files.

In an example, a computer-implemented method for monitoring safety of a project site may include receiving, at one or more processors communicatively coupled to an imaging system including one or more cameras, a set of unprocessed imaging data of a region of interest of the project site. The set of unprocessed imaging data may include a plurality of images captured by the imaging system. The computer-implemented method may further include processing, using an image processing model executed by the one or more processors, the unprocessed imaging data by deduplicating the plurality of images to generate a set of processed imaging data including one or more images, analyzing, using a vision large language model (LLM) executed by the one or more processors, the one or more images in the set of processed imaging data to identify a safety condition at the project site associated with at least one of (i) at least one physical structure or (ii) at least one project site state. The analyzing may include performing feature extraction to generate structured data representations of the one or more images. The analyzing may further include identifying a safety condition at the project site based on a relationship or label within the structured data representations, determining a semantic category corresponding to the safety condition via application of a transformer-based neural network to the safety condition, and generating a textual description that characterizes the identified safety condition present in the one or more images based on at least the semantic category corresponding to the safety condition.

Any of the systems, devices, and methods disclosed herein may include any of the following features. The one or more images each may include associated metadata, and the structured data representations may be generated further based on the metadata associated with the one or more images.

The computer-implemented method may further include transmitting, by the one or more processors, a safety standard request to a safety database server, receiving, by the one or more processors, a safety database response including safety standard data from the safety database server, and utilizing, by the one or more processors, the vision LLM to generate a safety report. The safety report may be based on at least one of the textual description or the safety standard data.

The safety standard data may include at least one standardized safety regulation.

The computer-implemented method may further include utilizing, by the one or more processors, the vision LLM to generate an analysis of the project site. The analysis may be based on the safety report.

The computer-implemented method may further include receiving, by the one or more processors, a data inquiry from a user device. The data inquiry may include at least one reference to a portion of the project site.

The computer-implemented method may further include utilizing, by the one or more processors, the vision LLM to generate a data response. The data response may be based on at least one of the safety report, the safety standard data, or the data inquiry.

The set of processed imaging data may be based on one or more source files that have had at least one of feature extraction, semantic segmentation, or edge detection applied by a preprocessing server.

The set of processed imaging data may include metadata including at least one of timestamp data, geolocation data, sensor data, lens data, photographic setting data, sensor calibration data, or sensor angle data.

The identification of the safety condition at the region of interest may be further based on the metadata.

The imaging system may include a 360-degree camera system or an unmanned aerial vehicle (UAV).

The deduplicating may include generating a plurality of bounding boxes. Each of the plurality of bounding boxes identifies (i) at least one physical structure or (ii) at least one project site state in a corresponding image of the plurality of images. The deduplicating may further include generating a plurality of rays. Each of the plurality of rays corresponds to a center of a corresponding bounding box of the plurality of bounding boxes. The deduplicating may further include determining that two or more generated rays intersect with one another. The intersection indicates that the bounding boxes corresponding to the two or more generated rays identify a same physical structure or a same project site state. The deduplicating may further include selecting a subset of the plurality of images to be the set of processed imaging data based on the determination that the two or more generated rays intersect with one another.

The imaging system may be configured to automatically capture, using the one or more cameras, a first image at a first time and a second image at a second time. An interval between the first time and the second time may be defined by the safety condition.

This disclosure may further include a system for automatically tracking safety conditions, the system may include one or more processors, and one or more non-transitory computer readable media storing instructions which, when executed by the one or more processors, cause the one or more processors to perform operations that may include receiving, from an imaging system that may include one or more cameras, a set of unprocessed imaging data of a region of interest of the project site. The set of unprocessed imaging data may include a plurality of images captured by the imaging system. The operations may further include processing, using an image processing model, the unprocessed imaging data by deduplicating the plurality of images to generate a set of processed imaging data including one or more images, analyzing, using a vision large language model (LLM), the one or more images in the set of processed imaging data to identify a safety condition at the project site associated with at least one of (i) at least one physical structure or (ii) at least one project site state. The analyzing may include performing feature extraction to generate structured data representations of the one or more images, identifying a safety condition at the project site based on a relationship or label within the structured data representations, determining a semantic category corresponding to the safety condition via application of a transformer-based neural network to the safety condition, and generating a textual description that characterizes the identified safety condition present in the one or more images based on at least the semantic category corresponding to the safety condition.

Any of the systems, devices, and methods disclosed herein may may include any of the following features. The one or more images may each include associated metadata, and the structured data representations may be generated further based on the metadata associated with the one or more images.

The operations may further include transmitting a safety standard request to a safety database server, receiving a safety database response may include safety standard data from the safety database server, and utilizing the vision LLM to generate a safety report. The safety report may be based on at least one of the textual description or the safety standard data.

The safety standard data may include at least one standardized safety regulation.

The operations may further include utilizing the vision LLM to generate an analysis of the project site. The analysis may be based on the safety report.

In a further example, one or more non-transitory computer readable media for automatically tracking safety conditions, may store instructions which, when executed by one or more processors, cause the one or more processors to perform operations that may include receiving, from an imaging system may include one or more cameras, a set of unprocessed imaging data of a region of interest of the project site. The set of unprocessed imaging data may include a plurality of images captured by the imaging system. The operation may further include processing, using an image processing model, the unprocessed imaging data by deduplicating the plurality of images to generate a set of processed imaging data including one or more images, analyzing, using a vision large language model (LLM), the one or more images in the set of processed imaging data to identify a safety condition at the project site associated with at least one of (i) at least one physical structure or (ii) at least one project site state. The analyzing may include performing feature extraction to generate structured data representations of the one or more images, identifying a safety condition at the project site based on a relationship or label within the structured data representations, determining a semantic category corresponding to the safety condition via application of a transformer-based neural network to the safety condition, and generating a textual description that characterizes the identified safety condition present in the one or more images based on at least the semantic category corresponding to the safety condition.

Any of the systems, devices, and methods disclosed herein may may include any of the following features. The operations may further include transmitting a safety standard request to a safety database server, receiving a safety database response may include safety standard data from the safety database server, and utilizing the vision LLM to generate a safety report. The safety report may be based on at least one of the textual description or the safety standard data.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

1. A computer-implemented method for monitoring safety of a project site, the computer-implemented method comprising:
receiving, at one or more processors communicatively coupled to an imaging system comprising one or more cameras, a set of unprocessed imaging data of a region of interest of the project site, wherein the set of unprocessed imaging data includes a plurality of images captured by the imaging system;
processing, using an image processing model executed by the one or more processors, the unprocessed imaging data by deduplicating the plurality of images to generate a set of processed imaging data including one or more images;
analyzing, using a vision large language model (LLM) executed by the one or more processors, the one or more images in the set of processed imaging data to identify a safety condition at the project site associated with at least one of (i) at least one physical structure or (ii) at least one project site state, wherein the analyzing comprises:
performing feature extraction to generate structured data representations of the one or more images;
identifying a safety condition at the project site based on:
applying, by the vision LLM, heuristics to determine a relationship between two or more objects identified by labels within the structured data representations; and
identifying the safety condition by associating a first object with the determined relationship, wherein the determined relationship is indicative of a hazardous state of the first object;
determining a semantic category corresponding to the safety condition via application of a transformer-based neural network to the safety condition; and
generating a textual description that characterizes the identified safety condition present in the one or more images based on at least the semantic category corresponding to the safety condition.

2. The computer-implemented method of claim 1, wherein the one or more images each include associated metadata, and the structured data representations are generated further based on the metadata associated with the one or more images.

3. The computer-implemented method of claim 1, further comprising:
transmitting, by the one or more processors, a safety standard request to a safety database server;
receiving, by the one or more processors, a safety database response including safety standard data from the safety database server; and
utilizing, by the one or more processors, the vision LLM to generate a safety report, wherein the safety report is based on at least one of the textual description or the safety standard data.

4. The computer-implemented method of claim 3, wherein the safety standard data comprises at least one standardized safety regulation.

5. The computer-implemented method of claim 3, further comprising:
utilizing, by the one or more processors, the vision LLM to generate an analysis of the project site, wherein the analysis is based on the safety report.

6. The computer-implemented method of claim 3, further comprising:
receiving, by the one or more processors, a data inquiry from a user device, wherein the data inquiry includes at least one reference to a portion of the project site.

7. The computer-implemented method of claim 6, further comprising:
utilizing, by the one or more processors, the vision LLM to generate a data response, wherein the data response is based on at least one of the safety report, the safety standard data, or the data inquiry.

8. The computer-implemented method of claim 1, wherein the set of processed imaging data is based on one or more source files that have had at least one of feature extraction, semantic segmentation, or edge detection applied by a preprocessing server.

9. The computer-implemented method of claim 1, wherein the set of processed imaging data includes metadata comprising at least one of timestamp data, geolocation data, sensor data, lens data, photographic setting data, sensor calibration data, or sensor angle data.

10. The computer-implemented method of claim 9, wherein the identification of the safety condition at the region of interest is further based on the metadata.

11. The computer-implemented method of claim 1, wherein the imaging system comprises a 360-degree camera system or an unmanned aerial vehicle (UAV).

12. The computer-implemented method of claim 1, wherein the deduplicating comprises:
generating a plurality of bounding boxes, wherein each of the plurality of bounding boxes identifies (i) at least one physical structure or (ii) at least one project site state in a corresponding image of the plurality of images;
generating a plurality of rays, wherein each of the plurality of rays corresponds to a center of a corresponding bounding box of the plurality of bounding boxes;
determining that two or more generated rays intersect with one another, wherein the intersection indicates that the bounding boxes corresponding to the two or more generated rays identify a same physical structure or a same project site state; and
selecting a subset of the plurality of images to be the set of processed imaging data based on the determination that the two or more generated rays intersect with one another.

13. The computer-implemented method of claim 1, wherein the imaging system is configured to automatically capture, using the one or more cameras, a first image at a first time and a second image at a second time, wherein an interval between the first time and the second time is defined by the safety condition.

14. A system for automatically tracking safety conditions, the system comprising:
one or more processors; and
one or more non-transitory computer readable media storing instructions which, when executed by the one or more processors, cause the one or more processors to perform operations comprising:
receiving, from an imaging system comprising one or more cameras, a set of unprocessed imaging data of a region of interest of the project site, wherein the set of unprocessed imaging data includes a plurality of images captured by the imaging system;
processing, using an image processing model, the unprocessed imaging data by deduplicating the plurality of images to generate a set of processed imaging data including one or more images;
analyzing, using a vision large language model (LLM), the one or more images in the set of processed imaging data to identify a safety condition at the project site associated with at least one of (i) at least one physical structure or (ii) at least one project site state, wherein the analyzing comprises:
performing feature extraction to generate structured data representations of the one or more images;
identifying a safety condition at the project site based on:
applying, by the vision LLM, heuristics to determine a relationship between two or more objects identified by labels within the structured data representations; and
identifying the safety condition by associating a first object with the determined relationship, wherein the determined relationship is indicative of a hazardous state of the first object a relationship or label within the structured data representations;
determining a semantic category corresponding to the safety condition via application of a transformer-based neural network to the safety condition; and
generating a textual description that characterizes the identified safety condition present in the one or more images based on at least the semantic category corresponding to the safety condition.

15. The system of claim 14, wherein the one or more images each include associated metadata, and the structured data representations are generated further based on the metadata associated with the one or more images.

16. The system of claim 14, the operations further comprising:
transmitting a safety standard request to a safety database server;
receiving a safety database response including safety standard data from the safety database server; and
utilizing the vision LLM to generate a safety report, wherein the safety report is based on at least one of the textual description or the safety standard data.

17. The system of claim 16, wherein the safety standard data comprises at least one standardized safety regulation.

18. The system of claim 17, the operations further comprising:
utilizing the vision LLM to generate an analysis of the project site, wherein the analysis is based on the safety report.

19. One or more non-transitory computer readable media for automatically tracking safety conditions, the one or more non-transitory computer readable media storing instructions which, when executed by one or more processors, cause the one or more processors to perform operations comprising:
receiving, from an imaging system comprising one or more cameras, a set of unprocessed imaging data of a region of interest of the project site, wherein the set of unprocessed imaging data includes a plurality of images captured by the imaging system;
processing, using an image processing model, the unprocessed imaging data by deduplicating the plurality of images to generate a set of processed imaging data including one or more images;
analyzing, using a vision large language model (LLM), the one or more images in the set of processed imaging data to identify a safety condition at the project site associated with at least one of (i) at least one physical structure or (ii) at least one project site state, wherein the analyzing comprises:
performing feature extraction to generate structured data representations of the one or more images;
identifying a safety condition at the project site based on:
applying, by the vision LLM, heuristics to determine a relationship between two or more objects identified by labels within the structured data representations; and
identifying the safety condition by associating a first object with the determined relationship, wherein the determined relationship is indicative of a hazardous state of the first object a relationship or label within the structured data representations;
determining a semantic category corresponding to the safety condition via application of a transformer-based neural network to the safety condition; and
generating a textual description that characterizes the identified safety condition present in the one or more images based on at least the semantic category corresponding to the safety condition.

20. The one or more non-transitory computer readable media of claim 19, the operations further comprising:
transmitting a safety standard request to a safety database server;
receiving a safety database response including safety standard data from the safety database server; and
utilizing the vision LLM to generate a safety report, wherein the safety report is based on at least one of the textual description or the safety standard data.
